(19) United States
(12) Patent Application Publication
(10) Pub. No.: US 2005/0005731 A1
(43) Pub. Date: Jan. 13, 2005

(54) Axle housing with reduced lubricant capacity

(76) Inventors: Lawrence D. Brill, Westerville, OH (US); Tomaz Dopico Varela, Gahanna, OH (US)

Correspondence Address: CARLSON, GASKEY & OLDS, P.C., 400 WEST MAPLE ROAD, SUITE 350, BIRMINGHAM, MI, 48009, US

(21) Appl. No.: 10/617,997

(22) Filed: Jul. 11, 2003

(51) Int. Cl. F16H 57/02

(52) U.S. Cl. 74/607

(57) ABSTRACT

An axle housing assembly includes web members that define lubricant containment chambers within an interior space of a housing. Each lubricant containment chamber contains a fixed amount of lubricant. The containment chambers defined within the housing confine lubricant to critical areas to reduce the amount of lubricant required within the housing to properly lubricate internal components.

### BACKGROUND OF THE INVENTION

This invention generally relates to a drive axle assembly, and specifically to a drive axle assembly configured to reduce the amount of required lubricant.

Typically, an axle housing includes a shaft suspended for rotation within the housing and driven by a drive mechanism also disposed within the housing. The housing is hollow throughout. A lubricant, such as oil, contained within the housing lubricates the drive mechanism. Further, lubricant within the housing lubricates bearing assemblies used to support drive axles within the housing. The amount of lubricant contained within the housing is dictated by the size and location of the drive mechanism and placement of the bearing assemblies.

One example of an axle housing that requires a significant amount of lubricant is an inverted portal drive axle housing. In an inverted portal axle, the shaft and drive hub rotate about different axes spaced a distance apart. This configuration allows a vehicle floor to be much lower than would otherwise be possible with conventionally configured axles. Typically, an inverted portal axle includes a drive mechanism disposed on one end of the axle housing and a drop gearbox on either end immersed in lubricant. Lubricant must cover the drive mechanism and helical gears to a required depth. The entire hollow interior of the housing must be filled with lubricant in order to obtain a proper level at the drive mechanism and both drop gearboxes. Much of the lubricant included within the housing is not in contact or near the drive mechanism. A large amount of lubricant is simply provided to ensure that a proper level of lubricant is present at the drive mechanism and drop gearboxes. Accordingly, much of the lubricant contained in the housing is not near the drive mechanism, drip gearboxes, or the bearing assemblies and is present only to ensure the proper level of lubricant in specific critical areas.

Typically, an inverted portal axle housing contains approximately 25 to 27 liters of lubricant to attain the proper level relative to the drive mechanism. This is periodically changed in order ensure that the desired lubrication properties are maintained within specified parameters. The lubricant removed from the axle housing during an oil change must be disposed. The sheer quantity of lubricant required to fill an axle housing causes disposal problems and increases operation and maintenance costs.

Accordingly, it is desirable to develop an axle assembly that reduces the amount of required lubricant while maintaining sufficient levels for proper lubrication of the drive mechanism and the bearing assemblies.

### SUMMARY OF INVENTION

An embodiment of this invention is an axle housing including web structures defining an internal chamber containing lubricant only in critical areas requiring lubrication.

The axle housing supports a shaft driven by a drive mechanism. A web member defines a lubricant containment chamber within the axle housing. The web member cooperates with the housing to form the lubricant containment chamber and prevent lubricant from being dispersed throughout the entire hollow interior of the housing. A shaft seal is provided within each web member to prevent lubricant leakage through a shaft web member interface.

The axle housing includes an internal cavity that runs the entire length of the axle housing from a first end to a second end. The web members are disposed at each end to define the lubricant containment chambers. The remaining areas within the axle housing do not receive lubricant and remain dry. Typically, an inverted portal axle assembly requires approximately 25 to 27 liters of lubricant, much of this lubricant dispersed in sections not requiring lubrication. The containments chambers defined within the axle housing assembly of this invention reduce the amount of required lubricant to approximately 17 to 19 liters.

Accordingly, this invention provides an axle housing containing lubricant only in areas requiring lubrication, reducing the quantity of lubricant required to maintain proper levels for the drive mechanism and bearing assemblies.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a cross-sectional view of an inverted portal drive axle including web members of this invention;

FIG. 2 is a cross-sectional view of a web member at the shaft interface; and

FIG. 3 is an enlarged cross-sectional view of an end of the axle housing.

### DETAILED DESCRIPTION OF THE PREFERRED EMBODIMENT

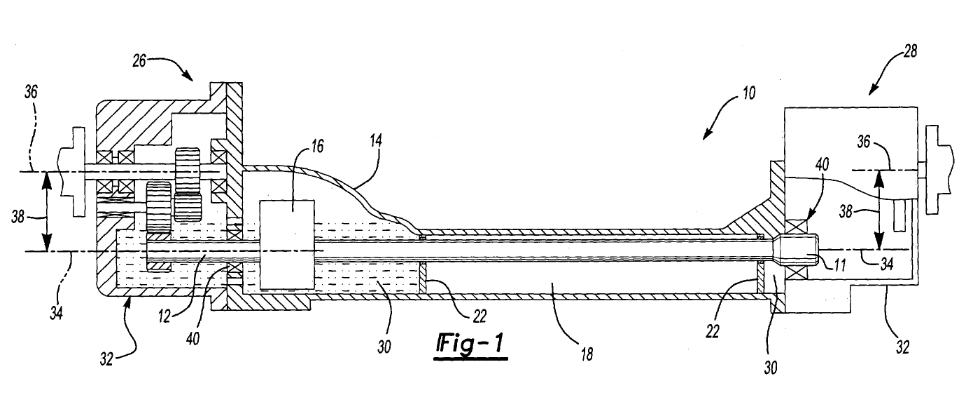

Referring to FIG. 1, an axle assembly 10 includes rotating shafts 11,12. The rotating shafts 11,12 are supported within a housing 14 by bearings 40 and is driven by a drive mechanism 16. The housing 14 includes web members 22 disposed within the housing 14 to define lubricant containment chambers 30. The lubricant containment chambers 30 are filled with lubricant 42 to a desired level to partially immerse the drive mechanism 16. Lubricant is prevented from being dispersed throughout a middle section 18 of the axle housing 14. By confining lubricant within the containment chambers 30, the amount of lubricant required to properly lubricate the drive mechanism 16 is reduced.

The axle housing 10 of this invention is an inverted portal axle having the shafts 11,12 rotating about a first axis 34 and a drop gearbox 32 with an output member rotating about a second axis 36. The first and second axes 34, 36 are disposed parallel to each other and are spaced apart a distance 38. The drive mechanism 16 is preferably a gearbox that transmits torque from a drive shaft to the axle shafts 11,12. The axle shafts 11,12 transmit torque from the drive mechanism 16 to the drop gearboxes 32. A drop gearbox 32 is disposed at first and second ends 26,28 of the housing 14. The specific configuration of the drive mechanism is as known to worker skilled in the art. The lower profile of the axle housing 14 allows the floor of a vehicle to be lowered below a driven wheel. Inverted portal axles are most often used in mass transit vehicles to allow the use of a lowered floor in order to aid entry and exit of passengers. As appreciated, the inverted portal axle is just one example of an axle housing configurations that may benefit from this invention.

The web members 22 define the lubricant containment chambers 30 at the drive mechanism 16 and the bearing assemblies 40 disposed at distal ends of the housing 14. The web members 22 are preferably an integrally cast part of the housing 14. Each web member 22 is a plate dividing a portion of the hollow interior of the housing 14. The web members 22 are positioned relative to the area within the housing 14 that requires lubricant. The containment chambers 30 defined by the web members 22 reduce the amount of lubricant required to obtain required lubricant levels for lubrication of the drive mechanism 16 and bearings assemblies 40.

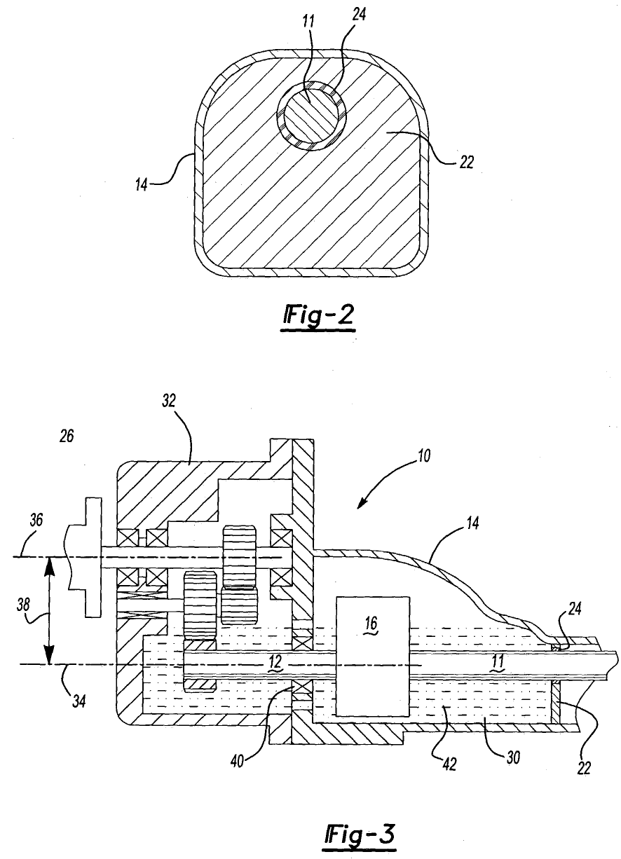

Referring to FIG. 2, the web member 22 includes a shaft seal 24 surrounding each shaft 11,12. The shafts 11,12 extend through the web member 22 to the drive mechanism 16 (FIG. 1). The drive mechanism 16 rotates the shaft 12. The seal 24 prevents lubricant from migrating past the web member 22 into the dry center section 18 of the housing 14.

Referring to FIG. 3, an enlarged view of the first end 26 of the axle assembly 10 is shown. The axle housing 14 includes the web member 22 and the shaft seal 24 that define the containment chambers 30. Lubricant 42 within the containment chamber 30 is filled to a desired level in order to provide proper lubrication of the drive mechanism 16 and drop gearboxes 32. This invention reduces the total amount of lubricant 42 required to immerse the drive mechanism 16 and drop gearbox 32 to the desired level.

Axle assemblies designed according to this invention reduce the amount of lubricant 42 required to lubricate the drive mechanisms 16, drop gearbox 32, and bearing assemblies that support rotation of the axle shafts 12. The web members 22 define the lubricant containment chambers 30 within the housing 14 such that only a portion of the housing contains lubricant. This feature reduces the amount of lubricant 42 by confining lubricant 42 to these portions of the housing 14 requiring lubrication.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

1. An axle housing assembly comprising:
a housing;
a shaft supported for rotation within said housing, and
a web member within said housing defining a lubricant containment chamber within a portion of said housing.

2. The assembly of claim 1, including a drive assembly within said lubricant containment chamber.

3. The assembly of claim 1, wherein said shaft extends through said web member.

4. The assembly of claim 3, wherein said web member includes a shaft seal disposed about said shaft for preventing lubricant leakage past said web member.

5. The assembly of claim 1, including two lubricant containment chambers within said housing.

6. The assembly of claim 5, wherein said lubricant containment chambers are disposed at distal ends of said housing.

7. The assembly of claim 5, including a middle section of said housing sealed between said web members at each end of said housing, said middle section not containing lubricant.

8. The assembly of claim 1, wherein said axle assembly rotates about a first axis and a wheel hub driven by said shaft rotates about a second axis spaced apart from said first axis.

9. The assembly of claim 8, including a hub driven by said shaft.

10. The assembly of claim 1, wherein said web member forms a lubricant containment cavity around a drive assembly.

11. An axle housing assembly comprising:
a housing defining an internal chamber;
a shaft supported for rotation within said housing; and
a web member disposed within said chamber restricting flow of a lubricant to a portion of said chamber.

12. The assembly of claim 11, including a drive mechanism disposed within said chamber containing lubricant.

13. The assembly of claim 11, wherein said shaft extends through an opening of said web member.

14. The assembly of claim 13, including a shaft seal cooperating with said shaft and said web member for preventing lubricant from passing out of said chamber containing lubricant.

15. The assembly of claim 11, including at least two web members restricting lubricant flow to distal ends of said internal chamber.
